(19) United States
(12) Patent Application Publication
(10) Pub. No.: US 2021/0239466 A1
(43) Pub. Date: Aug. 5, 2021

(54) Ziplot-Instant Graphical Elevation Measurement Documentation

(71) Applicant: Dennis Vories, Germantown, MD (US)

(72) Inventor: Dennis Vories, Germantown, MD (US)

(21) Appl. No.: 17/248,599

(22) Filed: Jan. 29, 2021

Related U.S. Application Data
(60) Provisional application No. 62/967,681, filed on Jan. 30, 2020.

(51) Int. Cl. G01C 5/04

(52) U.S. Cl. CPC G01C 5/04

(57) ABSTRACT

A system and method of associating elevations with locations on an image map. The image map of a jobsite, e.g., a lot or building. is displayed on an electronic screen on a computer such as a smartphone or smart tablet. A user interface is used to allow a user to locate multiple different markers on different locations of the image map on the electronic screen. A user sets a marker by dragging a cursor to a location. Information is received from an electronic elevation determination device automatically or by manual control. That information represents an elevation of the electronic elevation device at a physical location matching the selected marker on the image map. The elevation information is then automatically associated with and printed beside the selected marker.

This application claims priority from Provisional application No. 62/967,681, filed Jan. 30, 2020, the entire contents of which are herewith incorporated by reference.

### BACKGROUND

A common arduous task in construction is documenting job site elevations. This is done for a diverse variety of projects, including engineering, architectural and industrial planning, excavation, grading, foundations, landscaping, septic systems, pools/spas, foundation settlement, remodeling and forensics.

One example is building foundation settlement measurements and documentation often done by home inspectors. Elevations can be taken using a hydrostatic level or hydrostatic altimeter that measures the elevations. This allows the measurer to determine the elevations, and hence determine levels without without the need for line-of-sight.

A house floor plan sketch can be used. Floor elevation deviations can be taken near the corners and center of each room relative to a zero reference elevation, usually established near the center of the home. This hand annotated sketch is usually carried back to an office where its content is typed on a CAD drawing of the house floorplan and provided to the client as part of a home foundation settlement and home inspection report.

Another example is the planning required for a typical building construction project on an empty lot. A sketch of the site is populated with elevation measurements at dots located at property and proposed house corners, along boundary lines, along proposed driveways, sidewalks, boundary lines or other distinctive surface features to plan excavation, grading, slopes, drainage and import or export of soil. Measurements are usually done using an optical level, transit, rotary laser, total station or hydrostatic altimeter. Again, the documented sketch is returned to an office where the measurements are typed on a CAD drawing for incorporation in a site development plan and/or project bid.

Yet another example involves a typical architectural addition or modification to a building. Elevation and distance measurements are hand written on sketches of the existing structure elevation view and the site surface surrounding the structure and taken to the office where the measurements are typed on CAD drawings for planning and bidding the project.

### SUMMARY

The present application describes use of an electronic tool to mark locations on an electronic image of an image map, and to automatically associate elevations with those marked locations.

The present application uses a system which allows selecting points on an image map, and serially associating elevations with those points. A cursor is located at the points, and changes in in appearance and/or location once the points are populated with an elevation.

### BRIEF DESCRIPTION OF THE DRAWINGS

FIG. 1 shows a block diagram of the system;

FIG. 2 shows a flowchart of operation;

FIG. 3 shows an exemplary floor plan drawing used as an image map that can be used to receive the information;

FIG. 4 shows an exemplary satellite view used as an image map that can be used to receive the information; and

FIG. 5 shows an exemplary photograph used as an image map that can be used to receive the information.

### DETAILED DESCRIPTION

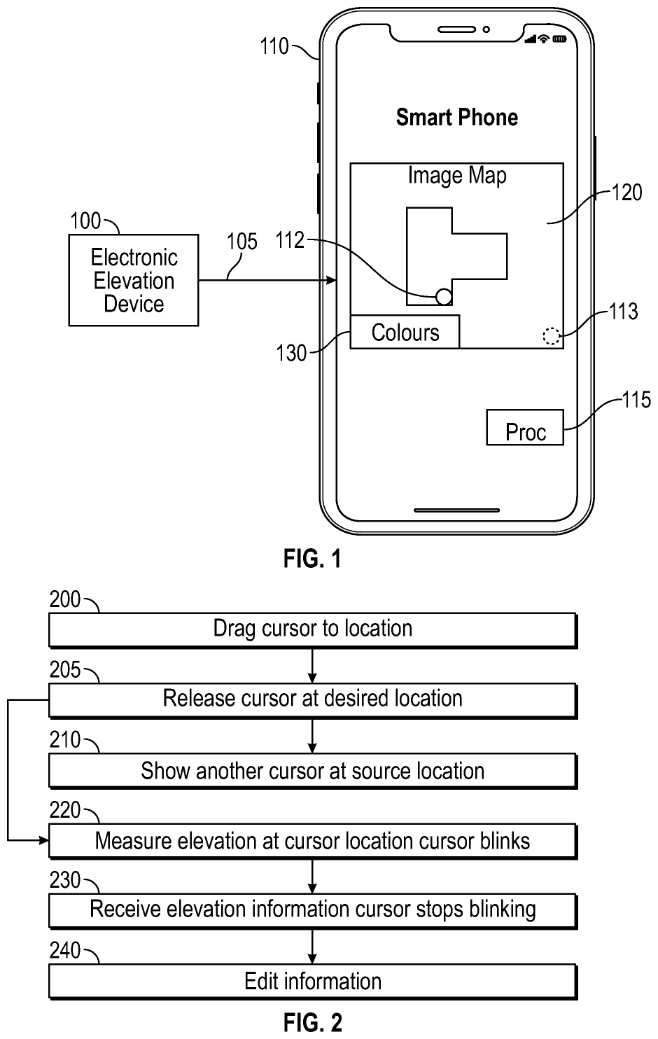

FIG. 1 shows an embodiment using an electronic elevation device 100 to automatically obtain elevation readings, and dissociate those elevation readings with points on an image map 120 of the area being imaged. The “computer’ as referred to herein could be a handheld computer, smart device phone, tablet with iOS or Android operating systems or similar processing electronics and operating systems.

The output 105 of the electronic elevation device 100 in FIG. 1 is received by a computer 110 which shows the image map 120 of the area being imaged. In an embodiment, the electronic elevation device can be any elevation measurement instrument such as the ZIPLEVEL PRO-2000 High Precision Altimeter, to record elevation readings. The ZIPLEVEL Pro-2000 is a hydrostatic altimeter device providing an electronic output indicative of elevation relative to a reference or benchmark. However, alternatively, this electronic elevation device 100 could be any device that measures elevation, including an electronic transducer, an electronic rotating laser with an output, a GPS device, which provides altimetry information, or any other precision altimetry device.

The output 105 of the electronic elevation device 100 can be a wired output. In an embodiment, the output of the electronic elevation device 100 is a wireless output such as via Wi-Fi, Bluetooth or any wireless format which provides information indicative of the altimetry reading. In an embodiment, a Bluetooth connection is established between the electronic elevation device 100 and a computer 110.

In an embodiment, the computer 110 may be an android or iOS smartphone or tablet that operates using a processor 115 with conventional computing hardware such as display driver, user interface, and memory. The computer has a screen 111, showing the image map 120. The image map 120 can be any image-based construct that shows the site plan, for example it can be a satellite map, floorplan, CAD drawing, screen shot, photographs, or any other image.

The operation proceeds as shown in FIG. 2. At 200, the user places the cursor 112 at a specific location on the image that matches where they physically want to measure. In operation, the user moves the cursor 112 to a location on the touchscreen. That location of cursor 112 is where the elevation is desired. In an embodiment, this moving is done on a touchscreen based device which is attached to the measurement device. For example, the Android device 110 may be a touchscreen phone in communication with the elevation measuring device 100. They can jointly be secured to a Unipod for ease of measurement.

After setting the location using the cursor, the elevation is automatically or manually recorded at the cursor location at 230.

One embodiment uses flashing cross hairs (shown as cursor 112) dragged by an operator at 200 from a source location 113 on the screen 120 to the location 112 of a desired measurement. Of course, other forms of cursors can also be used.

The cursor is released at 205. This allows a new cursor to appear at the source location 113 for dragging to another location of elevation measurement. In one embodiment, this enables the user to locate a number of different dots in advance of the actual measurement operation. This process of locating additional dots can continue until the user has marked all desired elevation locations on the image map. The process could be carried out in advance of taking all measurements such as in the comfort of a vehicle or office.

In another embodiment, the cursor locating and elevation measuring is done serially, measurement by measurement, on the job site.

At 220, the operator then places the measurement device 100 at a location represented by a flashing cross hair cursor. The user sends the measurement from the measurement device which is received at 230 replacing the flashing cursor with a dot and elevation. The flashing cursor returns to its source location on the touch screen, shown at 210.

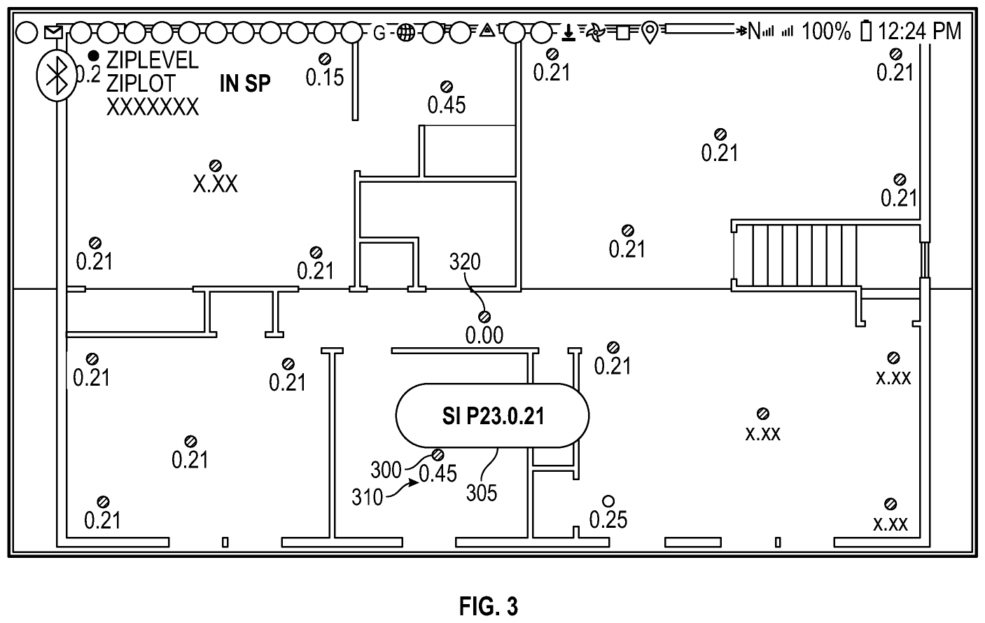

In one embodiment, illustrated in FIG. 3, each of the locations which have already been associated with elevation information are shown as solid green dots, such as 300 in FIG. 3. This is also associated with other information shown as 305, which can either be shown all the time, or can be viewed when the cursor is selected. The actual measured elevation 310 is shown adjacent each dot which has been measured. There are a number of spots shown in the FIG. 3 embodiment, which have already been elevation measured.

The hollow cursor shown as 320 in FIG. 3 represents the benchmark zero associated with the value 0.00.

In embodiments, the cursor changes color, shape, size and/or flash rate to indicate that the elevation is being recorded. At this point, an elevation 320 or numerical table label 305 is associated with each of the locations.

This process is repeated at the location of each desired elevation until the touch screen graphic elevations are measured at all desired elevation locations.

The dot edit operation is shown generically at 240. This enables the user to move, remove, or otherwise edit the dot. The dot at any location can be moved by finger contact at any time.

Finger contact on the dot for longer than three seconds without movement can either erase the dot along with any recorded elevation or can bring up an edit screen that rings up a pop-up menu with different options for moving or editing the cursor and hence the location of the dot.

The completed touch screen final form graphic and possible labels and elevation table can immediately be saved and/or shared with clients, coworkers and others.

There are numerous other ways of displaying, locating, moving, saving or deleting elevation locations on a graphic screen or touch screen, and all of these are contemplated to be included within the present system.

The system can use a number of different settings, which can be selected using the controls 130, and are saved until changed. These include:

Scale: IN, inches; FT, feet; CM, centimeters; M, meters

Precision: SP—standard precision (0.05″, 0.005′, 0.1 cm, 0.001 in)

HP—high precision (0.005″. 0.0005′, 0.01 cm, no meters)

Display Sign: Normal—reading increases when Measurement Module is raised for normal ZIPLEVEL use.

Inverted—reading decreases when Reference Cell goes down (Used with excavator EZDepth)

The record mode is entered to display data of Positions along Sequences on a DATA page, GRAPH profiles or to create a ZIPLOT, all of which are described herein. The user can press SHR/CLR to share or clear the Data and Graph pages.

The user presses the ZIPLEVEL ZERO for 2 seconds while the ziplevel is at a benchmark, to enter the Record Data Function by pressing REC+MARK for 2 sec. (flashing REC) and clear any existing data by pressing REC+ZERO for 2 sec then press HOLD momentarily to record data at each new Position or MARK for 2 sec. to start a new Sequence. Press ZERO 2 sec. then repetitively to backspace erase data.

The user presses the GRAPH control to show profiles of data. Sequences are graphed in 10 colors per decade. Use two fingers vertically to zoom in and out on precision or horizontally for Positrons. Pan up/down or left/right using finger. Press SHR/CLR to share or clear the Data and Graph pages.

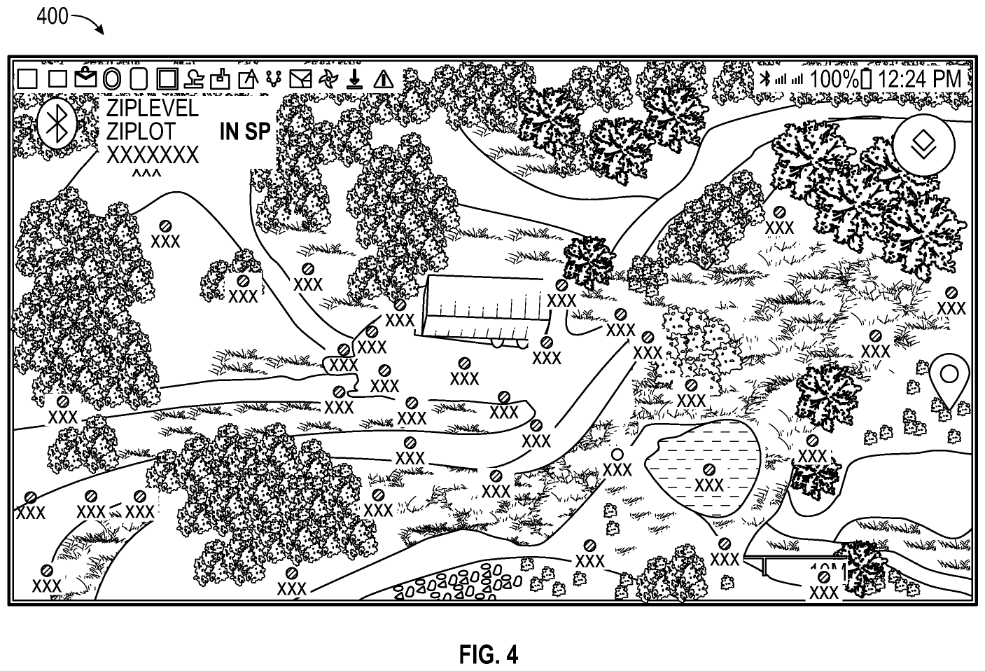

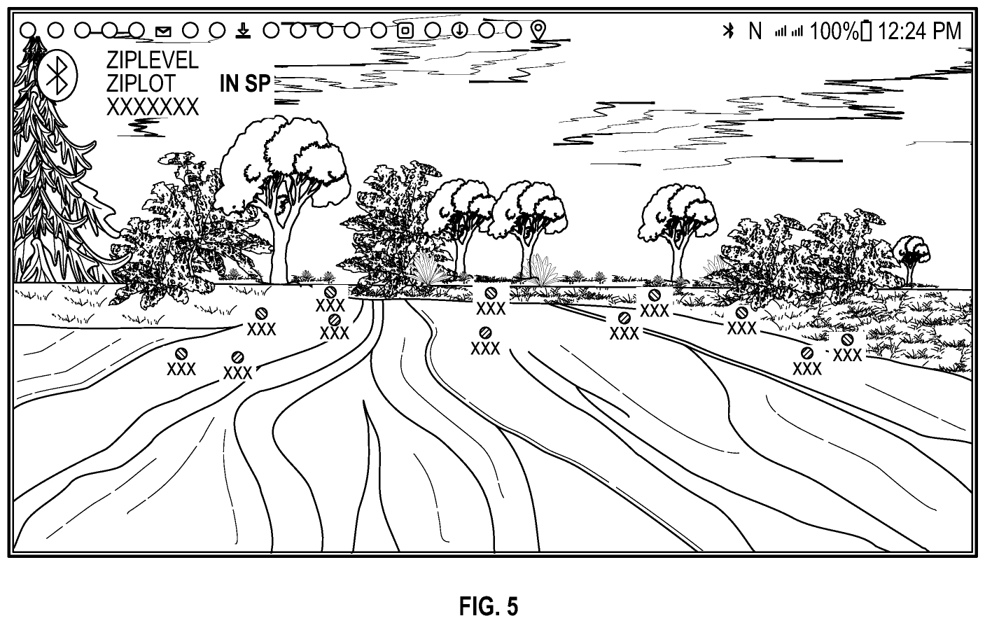

The user presses the ZIPLOT to plot data directly on image maps, e.g., photos such as 500 in FIG. 5, floor plans such as 350 in FIG. 3, satellite maps, such as 400 in FIG. 4, or other image maps. After importing the image maps, the image maps are annotated with points, dots, and values, as described herein.

To use this, the user presses IMPORT to create a plot background from either a PHOTO or the GALLERY.

1) Move the crosshairs to the location on the photo where the user takes a measurement and press HOLD on ZIPLEVEL. P1 of S1 will plot as a hollow dot indicating a benchmark reading usually at a user's Zero location.

2) Tap on a reading & immediately on COMMENT to add a comment from a pop up keypad or by voice.

3) Place and hold finger on any dot and listen for a click sound and without lifting finger reposition.

4) New Sequences will plot in up to 10 different colors before repeating the colors.

5) Tap and slide the brightness control as desired and tap the BlueTooth Icon to toggle hiding of buttons,

6) Save the ZIPLOT by a screenshot or press SHR/CLR to SHARE or CLEAR the ZIPLOT page.

7) Tap the return key to view ZIPLOT Data or Graphs or tap twice to return to the Home page.

The dump function can be entered by pressing ZIPLEVEL REC+MARK 2 sec. to exit the Record Data Function, The Android return key can be used to access DUMP from the Home page then press the ZIPLEVEL CAL+REC momentarily to dump all data stored in the ZIPLEVEL Record Data Registers. As with the SMARTLINK RECORD pages, view Graphs and Share or Clear Data and Graphs.

The monitor function is used to display elevation data or graphs at rates of three readings per second to one reading in four days. The user enters the Monitor Function as follows: With the ZIPLEVEL off, press ON/OFF+CAL until readings begin scrolling on the display followed by Monitor Data.

The user can press the RATE button to set the reading rate.

As with the SMARTLINK RECORD and DUMP pages view, Graphs and Share or Clear Data and Graphs are options. In addition, view a strip chart of the MONITOR GRAPH by zooming to the desired magnitude and time intervals using two fingers then pan fully to the left. The graphed data will then move to the left while retaining the preset intervals. The user can press the Android return key to return to the previous or Home page.

There are multiple different significant cost and labor saving benefits of this invention.

1) An image map, which can be a drawing, floor plan, satellite map, photograph or other graphic can be imported for superposition of elevations and/or entry of surface dimensions without the need for an initial sketch.

2) Readings are directly recorded in final form at all desired locations; the desired locations may all be preselected.

3) When the last site measurement is completed, the graphic can immediately be shared electronically with clients, co-workers or others without costly, time consuming and error inducing transcription of field notes onto final graphics back at the office. In the embodiment, this can be done using a program running on the Android or IOS device to send the information in a specified format.

Although only a few embodiments have been disclosed in detail above, other embodiments are possible and the inventors intend these to be encompassed within this specification.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of associating electronically measured elevations with locations on an image map, comprising:
obtaining and displaying an image map of a job site on an electronic screen on a computer;
operating a user interface which allows a user to locate multiple different markers on different locations of the image map on the electronic screen;
selecting a first marker on the electronic screen;
receiving information from an electronic elevation determination device, the information being electronic information that represents an elevation of the electronic elevation device at a location of the first marker; and
associating the information with the first marker, to thereby associate electronically measured elevation information with a marker.

2. The method as in claim 1, further comprising, after selecting the first markers, selecting a second marker that is in a different location, receiving information from the electronic elevation determination device for the different location, and associating the elevation information for the different location with the second marker.

3. The method as in claim 2, wherein the selecting the first marker comprises setting a first location of the first marker on the screen by dragging a cursor from a home location to the first location, and causing the electronically measured elevation information to be associated with the first marker, and then setting a second location of the second marker on the screen by dragging the cursor from the home location to the second location, and causing the electronically measured elevation information to be associated with the second marker.

4. The method as in claim 2, wherein the computer is a portable computer, and further comprising connecting via a wireless communication between the electronic elevation device and the portable computer.

5. The method as in claim 4, wherein the wireless communication is Bluetooth.

6. The method as in claim 4, wherein the portable computer is a smart phone.

7. The method as in claim 2, wherein the computer has a touchscreen.

8. The method as in claim 7, wherein the cursor is selected on the touchscreen by moving the cursor to a location, causing the cursor to start flashing until elevation information is completely received.

9. The method as in claim 8, wherein the cursor changes in one of appearance and location for a specific location once the elevation information has been completely received.

10. The method as in claim 1, wherein each marker has a first appearance when elevation information is associated therewith, and has a second, different appearance, when no elevation information is associated therewith.

11. A system of associating elevations with locations on an image map, comprising:
a computer, having a display, the computer obtaining and displaying an image map of a job site on the display;
the computer having a user interface which allows a user to locate multiple different markers on different locations of the image map on the display;
the computer enabling selecting a first marker on the display;
an electronic elevation determination device, the computer receiving information from the electronic elevation determination device, and the information being electronic information that represents an elevation of the electronic elevation device at a location of the first marker; and
the computer associating the information with the one of the markers, to thereby associate electronically elevation information with a marker.

12. The system as in claim 11, wherein the user interface is used, after selecting the first marker, for selecting a second that is in a different location, receiving information from the electronic elevation determination device for the different location, and associating the elevation information for the different location with the second marker.

13. The system as in claim 12, wherein the user interface allows selecting the first marker by setting a first location of the first marker on the screen by dragging a cursor from a home location to the first location, and causing the electronically measured elevation information to be associated with the first marker, and then setting a second location of the second marker on the screen by dragging the cursor from the home location to the second location, and causing the electronically measured elevation information to be associated with the second marker.

14. The system as in claim 12, wherein the computer is a portable computer, and communicates via a wireless communication between the electronic elevation device and the portable computer.

15. The system as in claim 14, wherein the wireless communication is Bluetooth.

16. The system as in claim 14, wherein the portable computer is a smart phone.

17. The system as in claim 12, wherein the computer has a touchscreen.

18. The system as in claim 17, wherein the cursor is selected on the touchscreen by moving the cursor to a location, causing the cursor to start blinking until elevation information is completely received.

19. The system as in claim 18, wherein the cursor changes in look for a specific location once the information has been completely received.

20. The system as in claim 11, wherein each marker has a first appearance when elevation information is associated therewith, and has a second, different appearance, when no elevation information is associated therewith.
